(19) United States
(12) Patent Application Publication
(10) Pub. No.: US 2021/0362745 A1
(43) Pub. Date: Nov. 25, 2021

(54) CONTROL METHOD FOR A VEHICLE, COMPUTER PROGRAM, NON-TRANSITORY COMPUTER-READABLE MEDIUM, AND AUTOMATED DRIVING SYSTEM

(71) Applicants: TOYOTA MOTOR EUROPE, Brussels (BE); TOYOTA JIDOSHA KABUSHIKI KAISHA, Toyota-shi, Aichi-ken (JP)

(72) Inventors: Niels FERSON, Brussels (BE); Kentaro KAMIJO, Toyota-shi (JP); Eiichiro MURATA, Toyota-shi (JP)

(73) Assignees: TOYOTA MOTOR EUROPE, Brussels (BE); TOYOTA JIDOSHA KABUSHIKI KAISHA, Toyota-shi, Aichi-ken (JP)

(21) Appl. No.: 16/963,373

(22) PCT Filed: Feb. 15, 2018
(86) PCT No.: PCT/EP2018/053824

§ 371 Date: Jul. 20, 2020

(51) Int. Cl. B60W 60/00; B60W 30/14; B60W 30/18; B60W 30/08

(52) U.S. Cl. CPC B60W 60/0015; B60W 30/08; B60W 30/18109; B60W 30/143

(57) ABSTRACT

A control method for a host vehicle (100), the method comprising the steps of:
a) acquiring a speed Vx of the host vehicle, a relative speed Vr between a preceding vehicle (200) and the host vehicle (100), and a relative distance Dr between the preceding vehicle and the host vehicle;
b) calculating a perceived risk level (PRL) as a function of said speed Vx of the host vehicle, said relative speed Vr, said relative distance Dr based on equation (1a):

PRL=PRL(Vr,Vx,Dr) (1a)
with the PRL function decreasing when Vx/dr increases, with Vr being constant;
c) controlling at least one vehicle device (32, 34, 36, 38) of the host vehicle as a function of the perceived risk level (PRL).

A computer program, a non-transitory computer-readable medium, and an automated driving system for implementing the above method.

### FIELD OF THE DISCLOSURE

The present invention relates to a control method which can be used to control vehicle devices of a host vehicle, a computer program, a non-transitory computer-readable medium, and an automated driving system.

An automated driving system is a motor vehicle driving automation system that is capable of performing part or all of the dynamic driving task (DDT) on a sustained basis.

An automated driving system can be mounted or is to be mounted in a car or a vehicle (such as a car, a truck, etc).

In the case of road vehicles, it may range in level from no driving automation (level 0) to full driving automation (level 5) according to SAE norm 33016. In order to realize this function, an automated driving system normally comprises at least one sensor, and an electronic control unit which transmits controls to actuator(s) of the vehicle (for instance to the steering column or shaft, the brake, the accelerator pedal or the like) to take some driving load off the driver.

An automated driving system is at least capable of assuming part of the driving task (for instance, to perform longitudinal control of the vehicle). In particular, many automated driving systems are designed to assist the driver and are therefore called Advanced Driver Assistance Systems (ADAS). Some automated driving systems are capable of assuming the whole driving task, at least during some periods. Such systems are classified at level 3, 4 or 5 according to SAE norm 33016.

The present invention concerns an automated driving system classified at any level from 1 to 5 according to SAE norm 33016.

### BACKGROUND OF THE DISCLOSURE

It is well known that many driving decisions are based on a ‘perceived risk’ perceived by the driver of a vehicle.

This ‘perceived risk’ aboard the host vehicle is a parameter which represents the risk perceived by a human driver who is driving the host vehicle. By extension, in case there is no driver in the vehicle, the ‘perceived risk’ is the risk that who would be perceived by a human driver driving the host vehicle at the time considered.

A ‘driving decision’ is any decision made by the driver and which leads to change the way the vehicle is controlled. For instance, typical driving decisions are decisions to brake, to accelerate, to turn left or right, and/or the combinations of these actions (when possible), and/or the increase/decrease of these actions.

When vehicles with partial or total automated driving (hereinafter, the ‘automated vehicles’) merge in the traffic, they have to merge with vehicles driven by humans. In order to maintain the highest safety level, a smooth integration of these vehicles requires in such circumstances that these automated vehicles behave in the traffic quite similarly to human-driven vehicles.

Consequently, it is necessary that the control systems of automated vehicles be capable of assessing the perceived risk perceived by human drivers when they are driving, so as to make driving decisions similarly to human beings.

It has been considered (see for instance document US 2007/0030132) that the perceived risk mainly depends on two parameters, the ‘time headway’ THW and the ‘time to collision’ TTC, defined as follows:
the time headway THW is the ratio between the host vehicle speed Vx and the relative distance dr between the host vehicle and the preceding vehicle:

THW=Vx/dr
the time to collision TTC is the ratio between the is the relative speed Vr between the host vehicle and the preceding vehicle and the relative distance dr between the host vehicle and the preceding vehicle:

TTC=Vr/dr.

It has been further considered that the perceived risk level (PRL), also called ‘Risk perception’ (RP), can be expressed in function of the time headway THW and the time to collision TTC by the following equation:

PRL=THW+αTTC (0)

where α is a constant.

However, studies have shown that the drivers in different countries have respectively different attitudes relative to risk. The perceived risk level PRL is country-dependent. For instance, it has been found that in the European Union, the distance when braking starts is much shorter than in Japan or in North America. It has also been noted that in the European Union, the driving speed has a smaller influence on the relative distance when braking starts than in Japan or in North America.

It has been found that the above equation (0) does not provide values of the perceived risk level PRL which are sufficiently accurate to estimate the perceived risk level, when the drivers may have different cultures, or may come from different countries, different continents.

Finally, no automated driving system and no control method for a vehicle has been identified which would correctly take into account (in particular, across several continents) the variety of perceived risk levels as really perceived by drivers.

Consequently, there is a need for an automated driving system and a control method for controlling various vehicle devices mounted in a vehicle during driving, which provides a correct estimate of the perceived risk level for the vehicle as perceived or as would be perceived by the driver, regardless of the country where the vehicle is driven. Based on such information, the controls issued by the automated driving system can be calculated so as to closely replicate human driving.

### SUMMARY OF THE DISCLOSURE

According to the invention, in order to meet the above need, a control method for a host vehicle is disclosed. Said control method comprises the steps of:

a) acquiring a speed Vx of the host vehicle, a relative speed Vr between a preceding vehicle and the host vehicle, and a relative distance Dr between the preceding vehicle and the host vehicle;

b) calculating a perceived risk level as a function of said speed Vx of the host vehicle, said relative speed Vr, said relative distance Dr based on equation (1a):

PRL=PRL(Vr,Vx,Dr) (1a)

with the PRL function decreasing when Vx/dr increases, with Vr being constant;

c) controlling at least one vehicle device of the host vehicle as a function of a perceived risk level.

In equation (1a), the perceived risk level is not a linear function of TTC as in above-mentioned equation (0), but may vary in function of Vr, Vx and Dr.

Advantageously, when the perceived risk level PRL function is chosen such that it decreases when Vx/dr increases, with Vr being constant, it has been observed the perceived risk level calculated based on equation (1a) corresponds more closely to the actual risk perception of drivers than a perceived risk level calculated on the basis of previous equation (0), at least for low values of the host vehicle speed (typically, speeds below 50 km/h). This reflects the fact that drivers who start braking at a short distance from the preceding vehicle (and therefore, when risk perception should be high) take less into account the time headway (THW) parameter when estimating the risk than drivers who start to brake at a relative long distance from the preceding vehicle.

In a preferred embodiment of the above-defined control method, the perceived risk level is calculated based on equation (1b):

PRL=(Vr+Y Vx)/(dr−X Vx) (1b)

in which X and Y are constants. Preferably, in the above-defined control method, X can be in the range −6,45 to −4,45, and Y can be in the range 2,4 to 4,4.

The definition of PRL proposed by equation (1b), in particular with the above-identified values of X and Y, is simple and has proved to provide excellent consistency with the actual perceived risk levels of a large group of drivers.

In an embodiment, the perceived risk level parameter PRL is used to allow a user of the vehicle, in particular the driver, to define the driving style of the vehicle. The user is therefore requested to input to the automated driving system a Maximum Risk Level (MRL) he or she considers as acceptable.

Accordingly in this embodiment of the above-defined control method, controlling at least one vehicle device of the host vehicle as a function of a perceived risk level includes controlling at least one vehicle device of the host vehicle as a function of a difference between the perceived risk level PRL and a predetermined maximum acceptable risk level.

In an embodiment, said at least one vehicle device includes at least one driving actuator. In this case, in step c), controlling said at least one vehicle device may include actuating said at least one driving actuator when the perceived risk level PRL exceeds a predetermined value.

In a particular implementation, the controlling step of the control method for a host vehicle is determined by computer program instructions.

Accordingly, the invention also provides a computer program which is stored on a non-transitory computer-readable medium, and which is suitable for being executed by a processor, the program including instructions adapted to perform the control method described above when it is executed by the processor.

The computer program may use any programming language, and be in the form of source code, object code, or code intermediate between source code and object code, such as in a partially compiled form, or in any other desirable form.

The invention also provides a non-transitory computer-readable medium storing instructions that, when executed by a processor, cause the processor to perform the control method mentioned above.

The computer-readable medium may be an entity or device capable of storing the program. For example, the computer-readable medium may comprise storage means, such as a read only memory (ROM), e.g. a compact disk (CD) ROM, or a microelectronic circuit ROM, or indeed magnetic recording means, e.g. a floppy disk or a hard disk.

Alternatively, the computer-readable medium may be an integrated circuit in which the program is incorporated, the circuit being adapted to execute or to be used in the execution of the control method in question.

Another object of the present invention is to provide an automated driving system for a host vehicle, comprising an electronic control unit configured

a) to acquire a speed Vx of the host vehicle, a relative speed Vr between a preceding vehicle and the host vehicle, and a relative distance Dr between the preceding vehicle and the host vehicle;

b) to calculate a perceived risk level PRL as a function of said speed Vx of the host vehicle, said relative speed Vr, said relative distance Dr based on equation (1a):

PRL=PRL(Vr,Vx,Dr) (1a)

with the PRL function decreasing when Vx/dr increases, with Vr being constant;

c) to control at least one vehicle device of the host vehicle as a function of the perceived risk level.

In an embodiment of this automated driving system, the electronic control unit is configured to calculate the perceived risk level PRL using equation (1b):

PRL=(Vr+Y Vx)/(dr−X Vx) (1b)

in which X and Y are constants. In this case, X can preferably be in the range −6,45 to −4,45, and Y can preferably be in the range 2,4 to 4,4.

In an embodiment of the automated driving system, the electronic control unit is configured, for controlling said at least one vehicle device, to control said at least one vehicle device as a function of a difference between the perceived risk level PRL and a maximum acceptable risk level.

In an embodiment of the automated driving system, the electronic control unit is configured to actuate at least one driving actuator among said at least one vehicle device when the perceived risk level PRL exceeds a predetermined value. (The vehicle device(s) is or are therefore one or more actuator(s)).

In an embodiment of the automated driving system, said at least one vehicle device includes at least one brake and/or at least one other driving actuator.

### BRIEF DESCRIPTION OF THE DRAWINGS

The present invention may be better understood and its numerous other objects and advantages will become apparent to those skilled in the art by reference to the accompanying figures in which:

FIG. 1 is a schematic drawing of a vehicle equipped with an automated driving system according to the present disclosure, represented behind a preceding vehicle;

FIG. 2 is a flowchart illustrating a vehicle control method according to the present disclosure;

FIG. 3 is a flowchart illustrating a vehicle control method according to the present disclosure, in the specific case of braking control;

FIG. 4 is a drawing illustrating a database of braking records; and

FIG. 5 is a drawing illustrating the database of braking records, wherein groups have been formed based on relative speed and vehicle speed, and each group is represented by a point.

### DESCRIPTION OF THE EMBODIMENTS

An automated driving system configured to implement one of the proposed methods for controlling a vehicle is now going to be described.

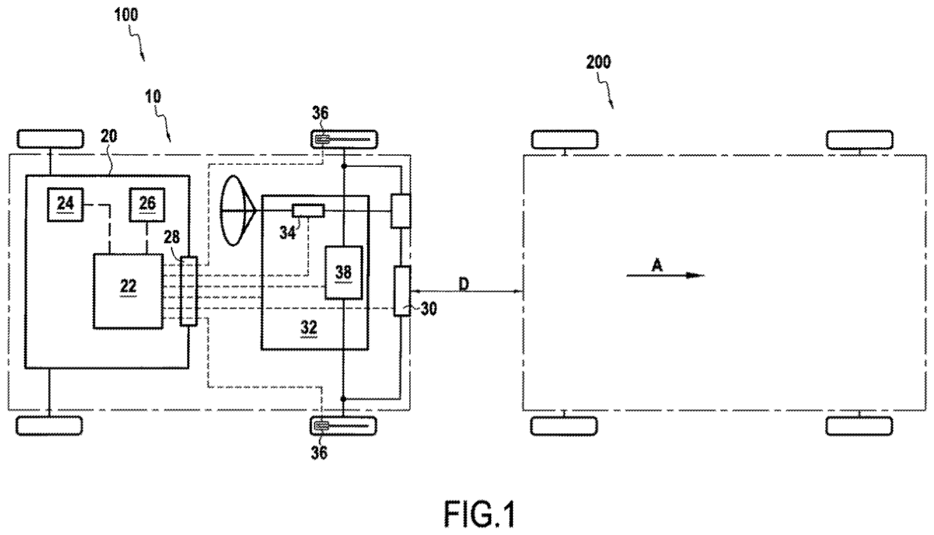

FIG. 1 schematically represents a car 100 (an example of a host vehicle) equipped with an automated driving system 10 which forms an exemplary embodiment of the present invention. Car 100 follows a ‘preceding vehicle’ 200. Both vehicle move in the direction shown by arrow A. The host vehicle and the preceding vehicle are separated by a distance Dr (Distance Dr appears proportionally much shorter on FIG. 1 than what it is in reality).

The automated driving system 10 (or, in short, the system 10) is, in the present case, an automated driving system comprising an electronic control unit 20 and several sensor units collectively referenced 30, comprising several cameras, a lidar unit, a set of radars, a close range sonar sensor unit, a GPS unit, a radio communication system for communicating with the infrastructure and/or with other vehicles, and a speed sensor measuring the speed Vx of the vehicle.

The radars of the set of radars in particular measure the relative speed Vr between the preceding vehicle 200 and the host vehicle 100.

All the above-mentioned sensor units 30 are connected to the electronic control unit 20 (ECU 20).

The ECU 20 has globally the hardware architecture of a computer. The ECU 20 comprises a microprocessor 22, a random access memory (RAM) 24, a read only memory (ROM) 26, an interface 28.

The hardware elements of ECU 20 are optionally shared with other units of the automated driving system 10 and/or other systems of the car 100.

The interface 28 includes in particular a tactile display and various displays mounted in or on the dashboard of the car.

The interface 28 therefore comprises a driver interface with a (not-shown) display to transmit information to the driver of the car 100, and interface connections with actuators and other vehicle devices of the car. In particular, interface 28 comprises a connection with several driving actuators of the car 100. These driving actuators include, but are not limited to, the engine 32, the steering column 34, the brakes 36, and the transmission 38.

The ECU 20 transmits torque requests to the engine ECU, and engagement controls to the respective engagement elements (e.g. clutches) of the transmission 38. Based on these controls, the engine ECU controls the torque delivered by the engine 32 and the transmission adopts the desired configuration, whereby the desired acceleration is imparted to the car.

A computer program configured to partly assume the driving task by performing lateral and longitudinal control of the vehicle is stored in memory 26. This program is configured to calculate the controls which, at least during some driving periods, control the driving actuators of the host vehicle.

This program, and the memory 26, are examples respectively of a computer program and a non-transitory computer-readable medium pursuant to the invention.

The read-only memory 26 of the ECU 20 indeed constitutes a non-transitory computer readable medium according to the invention, readable by the processor 22. It stores instructions which, when executed by a processor, cause the processor 22 to perform the control method according to the present invention.

More specifically, the program stored in memory 26 includes instructions for executing a method for controlling the driving actuators 32, 34, 36 and 38 as a function of the perceived risk level PRL.

The automated driving system 10 is designed to handle the driving tasks only under the constant supervision of the driver. System 10 is thus considered as an automated driving system of level 2 pursuant to SAE norm 33016. The present invention however can be implemented on automated driving systems of any level from 1 to 5.

To perform its function, system 10 uses data provided by sensors 30, processes the data in ECU 20, and controls the vehicle devices 32 of the car on the basis of controls calculated by ECU 20. In addition, information exchange between the vehicle 100 and external devices via interface 28 may also possibly take place to improve the performance of system 10.

As mentioned above, the ECU issues controls to control the actuators of car 100; these controls are calculated as a function of a perceived risk level PRL.

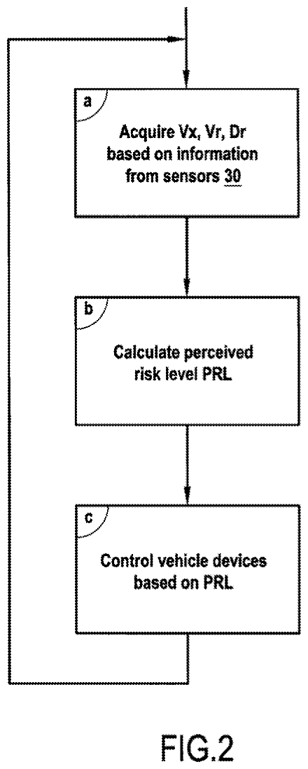

In accordance with the present disclosure, the vehicle 100 can be controlled during driving for instance pursuant to the control method illustrated by FIG. 2.

In this method, in a first step a), the relative speed Vr and the relative distance Dr between the host vehicle 100 and a preceding vehicle 200 are acquired by ECU 20, based on radar information provided by the radars of sensors 30. The host vehicle speed Vx is acquired from the speed sensor of sensors 30.

Then, at step b), the perceived risk level PRL is calculated.

The perceived risk PRL can only be calculated in a situation where the host vehicle 100 is following a preceding vehicle 200, as illustrated on FIG. 1.

The perceived risk level PRL is calculated by ECU 20 as follows.

The relative speed Vr and the relative distance Dr between the host vehicle 100 and a preceding vehicle 200 are calculated by ECU 20 based on radar information provided by the radars of sensors 30.

The host vehicle speed Vx is further acquired from the speed sensor of sensors 30.

The perceived risk level PRL is then calculated in accordance with a calculation method which will be presented below.

Then, in a third step c), one or more vehicle device of the host vehicle 100 is controlled or activated depending on the value of the perceived risk level PRL. For instance, the brakes 36 can be applied; the timing (or the distance Dr) at which braking is triggered is determined based on the perceived risk level PRL.

The algorithm is carried out iteratively at regular time steps. After controls have been issued for the various driving actuators at step c), the algorithm is resumed at step a).

Various variables—or various devices—of the vehicle 100 can be controlled by the automated driving system 10, based on the perceived risk level. Usually, the driving system 10 is configured to modify the braking force, the acceleration or torque of the engine, and/or the steering angle of the vehicle based on the perceived risk level.

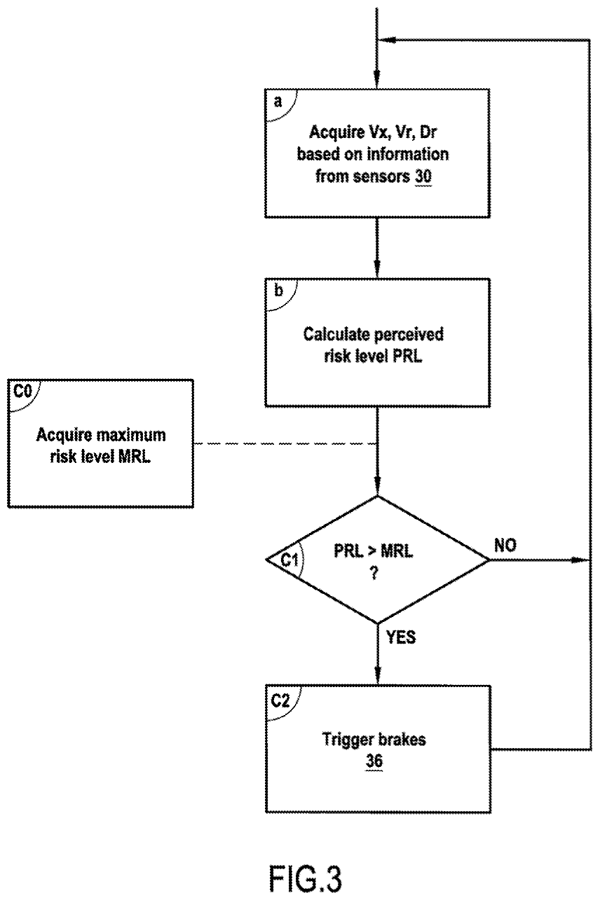

Another and more specific exemplary control method of a vehicle in accordance with the present disclosure will now be described in relation with FIG. 3.

In this embodiment, in vehicle 100 the driver has the possibility to specify the maximum accepted risk level (‘MRL’) which it the maximum risk to which he or she wants to be exposed while the automated driving system 10 drives the car.

Based on this parameter, in vehicle 100, the controls sent to the vehicle devices 32, 34, 36 and 38 take into account the difference between the calculated perceived risk level PRL, and the desired perceived risk level MRL specified by the driver.

By this setting, the driver can request the driving system to adopt a more or less aggressive driving style.

The control of vehicle 100 is realized by ECU 20 which executes an algorithm substantially identical to the algorithm of FIG. 2.

The first steps a) and b) of this algorithm are identical to steps a) and b) of the preceding method.

However, in this embodiment, step c) of controlling the driving actuators is carried out as follows in two steps c1) and c2).

Beforehand, in a step c0), the user of the vehicle is requested to input the maximum risk level MRL he or she is willing to accept during the trip, and which he or she considers acceptable.

During the trip, each time a preceding vehicle is detected in front of the host vehicle in the same lane as the host vehicle, the perceived risk level PRL is calculated at step b).

Then at a step c1), the perceived risk level PRL is compared to the maximum risk level MRL previously inputted by the user of the vehicle. That is, the difference between PRL and MRL (PRL−MRL) is calculated.

If this difference is negative, that is, if the perceived risk level PRL does not exceed the maximum risk level MRL, no further action is taken and the algorithm jumps to step a), which is carried out at the next time step.

Conversely, if this difference is positive, that is, the perceived risk PRL exceeds the maximum risk level MRL, then the algorithm jumps to step c2). In step c2), the control unit 20 controls the brakes 36 to be applied. That is, in this latter case a control value is outputted by the control unit 20 and, based on this value, the brakes 36 are applied.

An exemplary method to calculate the perceived risk level (PRL) is now going to be presented.

In this method, the perceived risk level parameter PRL is calculated as follows as a function of Vr, Vx and Dr. It is assumed that:

PRL=(Vr+Y Vx)/(Dr−X Vx) (1b)

The following values are chosen for X and Y: X=−5,45 and Y=3,4. Therefore:

PRL=(Vr+3,4 Vx)/(Dr+5,45 Vx).

It can be easily confirmed with this function that PRL decreases when Vx/Dr increases, with Vr being constant. Other assumptions can be made for function PRL.

The control methods illustrated by FIGS. 2 and 3 are only exemplary embodiments of the present disclosure.

More generally, as mentioned before, many different functions or systems of a car or a road vehicle can be controlled based on the perceived risk level. Usually, the driving system of the vehicle is configured to modify the braking force, the acceleration or torque of the engine, and/or the steering angle of the vehicle based on the perceived risk level. The driving system of the vehicle however may also trigger warning signals (visual, audible, haptic) based on the perceived risk level. Accordingly, emission devices used to emit said visual, audible and/or haptic signal are other examples of vehicle devices which can be controlled based on the PRL parameter, in accordance with the present disclosure.

Although the present invention has been presented above with a PRL function based on equation (1a), the invention is by no means limited to this specific value of the PRL function or by equation (1a) or (1b). As explained above, the invention can be implemented with many different PRL functions.

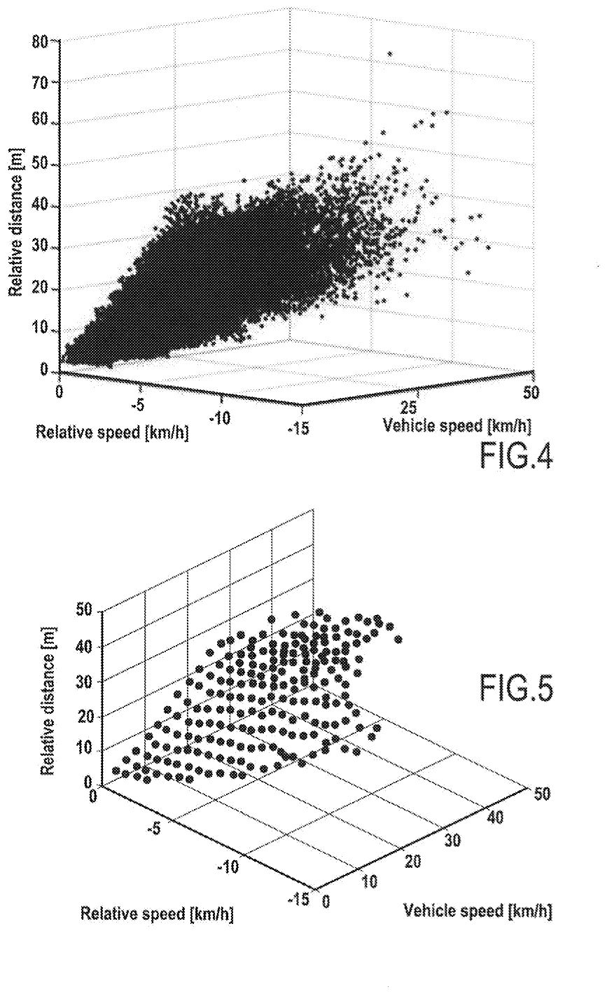

In the development of a control system for a vehicle, if using a specific PRL function is considered, it is possible to check whether this function provides an effective value of the PRL parameter by using the following verification method (FIGS. 4 and 5):

### a) Database Establishment

First, a database of exemplary brakings by drivers in representative driving situations is constituted.

This database contains records of brake applications having taken place during driving. For each brake application, the record of the database includes at least the following information: the vehicle speed Vx, the relative speed Vr and the relative distance Dr between the host vehicle and the preceding vehicle, at the time the brakes were applied.

The database of braking records is represented on FIGS. 4 and 5. Each point of FIG. 4 represents a braking event which has been recorded for a vehicle. All these braking events are plotted in an axis system comprising the Vehicle speed Vx, the relative speed between the vehicle and the preceding vehicle, Vr, and the relative distance between the two vehicles, Dr.

### b) Establishment of Data Groups

The braking records are then grouped based on relative speed Vr and vehicle speed Vx. For instance, the total range of speeds of the relative speeds is divided into ten ranges Vri (i=1 . . . 10); similarly, the total range of speeds of the vehicle speeds is divided into ten ranges Vxj (j=1 . . . 10).

The groups (Vri,Vxj) obtained in this manner are shown on FIG. 5. Each point is represented by a dot showing the mean relative distance Dr_database for the group.

Then, the mean relative distance Dr_database (Vri,Vxj) is calculated for each group (Vri,Vxj), based on the numerical values of Dr contained in the database.

### c) Evaluation of the Accuracy of the PRL Function

For each group (Vri,Vxj), the relative distance at brake start (Dr_calculated (Vri,Vxj)) is then calculated, based on the PRL function whose accuracy is to be evaluated.

The accuracy of the PRL function can then be evaluated based on the following formula:

$$Accuracy = {\sum }_{Vri , Vxj} \frac{Dr\_calculated ( Vri , Vxj )}{Dr\_database ( Vri , Vxj )}$$

Based on this formula, the accuracy of various PRL functions can be compared. This makes it possible to confirm that a PRL function which is evaluated provides more accurate results than other known PRL functions.

In particular, it has been possible to conclude that the above-presented embodiments of the PRL function in accordance with the present disclosure provide values of the perceived risk level PRL which are significantly more accurate than prior art PRL functions such as the PRL functions based on equation (0).

1. A control method for a host vehicle, the method comprising the steps of:
a) acquiring a speed Vx of the host vehicle, a relative speed Vr between a preceding vehicle and the host vehicle, and a relative distance Dr between the preceding vehicle and the host vehicle;
b) calculating a perceived risk level PRL as a function of said speed Vx of the host vehicle, said relative speed Vr, said relative distance Dr based on equation (1a):
PRL=PRL(Vr,Vx,Dr) (1a)
with the PRL function decreasing when Vx/Dr increases, with Vr being constant;
c) controlling at least one vehicle device of the host vehicle as a function of the perceived risk level.

2. A control method according to claim 1, wherein the perceived risk level PRL is calculated using equation (1b):
PRL=(Vr+Y Vx)/(Dr−X Vx) (1b)
in which X and Y are constants.

3. A control method according to claim 2, wherein X is in the range −6,45 to −4,45, and Y is in the range 2,4 to 4,4.

4. A control method according to claim 1, wherein in step c), controlling at least one vehicle device includes controlling at least one vehicle device as a function of a difference between the perceived risk level and a predetermined maximum acceptable risk level.

5. A control method according to claim 1, wherein step c) includes actuating at least one driving actuator among said at least one vehicle device when the perceived risk level PRL exceeds a predetermined value.

6. A control method according to claim 1, wherein said at least one vehicle device includes at least one brake and/or at least one other driving actuator.

7. A computer program which is stored on a non-transitory computer-readable medium, and which is suitable for being executed by a processor, the program including instructions adapted to perform the control method according to claim 1 when it is executed by a processor.

8. A non-transitory computer-readable medium storing instructions that, when executed by a processor, cause the processor to perform the control method of claim 1.

9. An automated driving system for a host vehicle, the automated driving system (10) comprising an electronic control unit configured
a) to acquire a speed Vx of the host vehicle, a relative speed Vr between a preceding vehicle and the host vehicle and a relative distance Dr between the preceding vehicle and the host vehicle;
b) to calculate a perceived risk level PRL as a function of said speed Vx of the host vehicle, said relative speed Vr, said relative distance Dr based on equation (1a):
PRL=PRL(Vr,Vx,Dr) (1a)
with the PRL function decreasing when Vx/Dr increases, with Vr being constant;
c) to control at least one vehicle device of the host vehicle as a function of the perceived risk level.

10. An automated driving system according to claim 9, wherein the electronic control unit (20) is configured to calculate the perceived risk level using equation (1b):
PRL=(Vr+Y Vx)/(Dr−X Vx) (1b)
in which X and Y are constants.

11. An automated driving system according to claim 10, wherein X is in the range −6,45 to −4,45, and Y is in the range 2,4 to 4,4.

12. An automated driving system according to claim 9, wherein the electronic control unit is configured, for controlling said at least one vehicle device, to control said at least one vehicle device as a function of a difference between the perceived risk level and a maximum acceptable risk level.

13. An automated driving system according to claim 9, wherein the electronic control unit is configured to actuate at least one driving actuator among said at least one vehicle device when the perceived risk level PRL exceeds a predetermined value.

14. An automated driving system according to claim 9, wherein said at least one vehicle device includes at least one brake and/or at least one other driving actuator.
